(19) United States
(12) Patent Application Publication
(10) Pub. No.: US 2014/0352294 A1
(43) Pub. Date: Dec. 4, 2014

(54) COLD WIND GENERATION FROM SLAG HEAT

(71) Applicant: PAUL WURTH S.A., Luxembourg (LU)

(72) Inventors: Marc Solvi, Ehlange (LU); Louis Schmit, Luxembourg (LU)

(21) Appl. No.: 14/365,669

(22) PCT Filed: Dec. 14, 2012
(86) PCT No.: PCT/EP2012/075536

§ 371 Date: Jun. 16, 2014

(30) Foreign Application Priority Data
Dec. 16, 2011 (LU) 91917

(51) Int. Cl. F04D 25/04

(52) U.S. Cl. CPC F04D 25/045; F05D 2210/12; F05D 2260/20
USPC 60/517

(57) ABSTRACT

The present invention describes a method for generating cold-air blast from slag heat, wherein the method comprises the following steps: a. providing hot, granulated slag, b. providing wet blast furnace gas, c. preheating the wet blast furnace gas, whereby preheated blast furnace gas is obtained, d. transferring heat from the hot, granulated slag to the preheated blast furnace gas, wherein hot blast furnace gas is obtained, e. expanding the hot blast furnace gas in a turbine, wherein energy is released and expanded blast furnace gas is obtained, f. using the released energy to drive a cold-air blast compressor for compressing the cold-air blast, wherein a shaft is driven by expansion of the hot blast furnace gas in a turbine, wherein said shaft drives the cold-air blast compressor and wherein the expanded blast furnace gas is used for preheating the wet blast furnace gas, whereby cold, expanded blast furnace gas is obtained.

### TECHNICAL FIELD

The present invention relates in general to a method and to an installation for generating cold-air blast from slag heat.

### BACKGROUND

Producing pig iron in a blast furnace requires a considerable energy input for generating compressed air (known as cold-air blast) serving as combustion air and for heating and melting the feedstock and for reducing iron-oxygen compounds. Disregarding the mechanical or electrical drive of the cold-air blast compressor, a major part of this energy is supplied in the form of organic carbon compounds, primarily as coke, and in addition alternatively as solid (e.g. coal dust), liquid (e.g. heavy oil) or gaseous (e.g. natural gas) “substitute reducing agents”. Conversion of these carbon compounds gives rise to a considerable CO₂ emissions.

This elevated energy input and the resultant environmental impact justify further efforts to recover the residual energy present in the starting materials and waste products.

Utilizing blast furnace gas as a fuel gas for heating the cold-air blast in “blast stoves”, for operating heating furnaces in rolling mills and for obtaining electrical energy in thermal power stations has in part been known since the 19^{th} century. Using blast furnace gas as a fuel gas does, however, require that it is extensively free of contamination by solid particles. To date, the gas cleaning required for this purpose is very predominantly carried out as wet cleaning with the consequence that the sensible heat of the blast furnace gas is very largely lost.

Utilizing the pressure energy of blast furnace gas by work-releasing expansion in a blast furnace gas “expansion turbine” has likewise been prior art for decades. The power obtainable in the turbine is determined both by the available pressure gradient between the gas outlet from gas cleaning and the gas inlet into a clean gas system and by the gas temperature at the gas cleaning outlet and thus at the turbine inlet. As explained in the preceding section, this gas temperature is mainly determined by wet cleaning and is thus only slightly above ambient temperature.

The output power available at the expansion turbine shaft is generally used for generating electrical energy with the assistance of a generator coupled to the turbine. The driving power required for the cold-air blast compressor is conventionally supplied by an electric motor or by a steam turbine.

Patent application WO 2011/026940 describes a method for increasing the blast furnace gas inlet temperature into the turbine and thus the power output in the turbine with the assistance of two-stage preheating and on condition that the inlet temperature of the expanded blast furnace gas in the clean gas system is kept below the limit value for gas temperature in the clean gas system. The first stage of preheating the blast furnace gas to be expanded proceeds by heat transfer from the expanded blast furnace gas, while the second stage of preheating proceeds with the assistance of external energy. Shifting expansion into increasingly higher temperature ranges means that, disregarding losses, the increase in turbine power output is equal to the increase in supplied external energy.

JP 62 074009 describes a method for recovering energy from hot granulated blast furnace slag. Blast furnace gas emerging from the blast furnace is dedusted and then, making use of the pressure difference, expanded in a turbine. The turbine is mechanically coupled to an electricity generator. Before entering the turbine, the dedusted blast furnace gas is heated by means of heat recovery using a heat-transfer medium. The heat-transfer medium transfers the heat from the recirculated granulated slag to the dedusted blast furnace gas.

DE 40 30 332 discloses a method for recovering energy from the blast furnace gas originating from a blast furnace. No energy is obtained from the slag. The finely and roughly dedusted blast furnace gas is expanded in an expansion turbine which can be coupled to an electricity generator before being introduced into a furnace gas system for further use. Two compressors and an electricity generator are mechanically coupled to the shaft driven by the turbine. Blast furnace gas and air are drawn in by the two compressors, compressed and then supplied to a combustion chamber where they are combusted with addition of a fuel with a high calorific value. Following combustion, the combusted mixture is expanded in a blast furnace gas expansion turbine to the turbine outlet pressure with release of energy.

### BRIEF SUMMARY

The invention provides an alternative method for energy recovery in the production of pig iron in a blast furnace and a corresponding installation.

The invention further provides a method for generating cold-air blast from slag heat, wherein the method comprises the following steps:
a. providing hot, granulated slag,
b. providing wet blast furnace gas,
c. preheating the wet blast furnace gas, whereby preheated blast furnace gas is obtained,
d. transferring heat from the hot, granulated slag to the preheated blast furnace gas, wherein hot blast furnace gas is obtained,
e. expanding the hot blast furnace gas in a turbine, wherein energy is released and expanded blast furnace gas is obtained,
f. using the released energy to drive a cold-air blast compressor for compressing the cold-air blast wherein the compressed cold-air blast is passed into the blast furnace
   wherein a shaft is driven by expansion of the hot blast furnace gas in a turbine, wherein said shaft drives the cold-air blast compressor and wherein the expanded blast furnace gas is used for preheating the wet blast furnace gas, whereby cold, expanded blast furnace gas is obtained.

In the course of the work leading to the present invention, it was established that heat recovery from the molten slag can be used for heating the blast furnace gas upstream from the turbine since the achievable power output from the turbine is roughly equal to the necessary shaft power of the cold-air blast compressor, whereby additional savings of external energy can be made.

Using the heat obtained from the slag for generating cold-air blast has the advantage that heat recovery and utilization proceeds within the boundaries of the same installation and timewise in parallel, as a result of which it is possible to avoid conversion into electricity, as explained in WO 2011/026940 and JP 62 074009, and thus the losses in an electrical generator for generating power and in an electric motor for driving the compressor can be avoided.

In contrast to DE 40 30 332, the compressed cold-air blast is passed into a blast furnace as combustion air. Advantageous features of such a configuration are simplified operation, lower costs and elevated efficiency. As is clear from the teaching in relation to continuous flow machines, the compressor is in many cases one of the limiting factors for increasing efficiency. This is particularly the case with relatively small continuous flow machines which have to run at high rotational speeds in order to achieve the pressure gradient necessary for elevated efficiency. High rotational speeds inevitably result in elevated secondary losses in the flows which distinctly reduce efficiency. DE 40 30 332 therefore also makes use of two compressors for operating a turbine, which naturally considerably increases the costs of such an installation.

The method according to the invention is particularly advantageous because the quantity of compressed gas is independent of the quantity of expanded gas and thus, thanks to this additional degree of freedom, the compressor and turbine can be operated at optimum efficiency.

According to a preferred embodiment of the method, the wet blast furnace gas has a pressure of 2 to 4 bar(g) and a temperature of 30 to 60° C.

The preheated blast furnace gas preferably has a pressure of 2 to 4 bar(g) and a temperature of 140-200° C.

The hot blast furnace gas preferably has a pressure of 2 to 4 bar(g) and a temperature of 300 to 420° C.

The expanded blast furnace gas preferably has a pressure of 0.05 to 0.4 bar(g).

The hot, expanded blast furnace gas preferably has a temperature of 400 to 290° C.

The cold, expanded blast furnace gas preferably has a temperature of 30 to 80° C.

The hot, granulated slag is preferably provided in that hot liquid slag is cooled by introduction of a cold solid and solidifies. The cold solid used is preferably cooled, vitreously solidified slag and/or metal bodies, wherein the spherical or similarly shaped metal bodies are preferably of iron or steel.

Heat transfer from the hot, granulated slag to the wet blast furnace gas preferably proceeds in a moving-bed cooler, in a tubular cooler and/or in a ball mill or tube mill.

The blast furnace gas input into the above-stated method for heat recovery has an elevated temperature due to the preheating which has already taken place in the preheater between expanded blast furnace gas and blast furnace gas which is yet to be expanded. Cooling of the slag may therefore be limited and a second heat recovery stage to recover the energy remaining in the slag may optionally be carried out subsequently.

### EXAMPLE CALCULATION

The example relates to a blast furnace with a pig iron output of 10,000 metric tons/d. The cold-air blast rate (dry) amounts to 1,000 Nm³/metric ton, the blast furnace gas rate to 1,700 Nm³/metric ton.

The cold-air blast pressure amounts to 4.5 bar gauge (bar(g)). At a compressor efficiency of 0.8036 (internal efficiency 82%, mechanical efficiency 98%), the calculated power requirement at the compressor coupling of the cold-air blast compressor for producing 423,875 Nm³/h of moist cold-air blast amounts to 34.28 MW.

The blast furnace gas pressure of the blast furnace amounts to 2.5 bar(g), the blast furnace gas pressure after wet gas cleaning to 2.2 bar(g) at a temperature of 45° C. The cleaned blast furnace gas, calculated flow rate 754,830 Nm³/h moist, is heated by the expanded blast furnace gas from 45° C. to 170° C., while conversely the expanded blast furnace gas is cooled from 243° C. to 65° C. The pressure drop in the heat exchanger in each case amounts to 0.1 bar, while the clean gas system pressure is 0.1 bar(g).

In a second heat exchanger, the blast furnace gas is heated from 170° C. to 362° C. The thermal output required for this purpose amounts to 59.95 MW. The pressure drop of the blast furnace gas in this second heat exchanger again amounts to 0.1 bar.

In the turbine, the blast furnace gas is then expanded from 2.0 bar(g) to 0.2 bar(g). The corresponding temperature drop proceeds from 362° C. to 243° C. At an efficiency of 0.8526 (internal efficiency 87%, mechanical efficiency 98%), the power output at the shaft amounts to 34.28 MW, and is thus equal to the above-stated power requirement at the shaft for generating the cold-air blast.

At a slag rate of 200 to 300 kg/metric ton and a slag enthalpy of 1,700 to 2,100 kJ/kg, the available gross heat content of the slag amounts to 39 to 73 MW and is thus in the region of the above-stated 59.95 MW for heating the blast furnace gas upstream of the turbine. Of course, the gross heat content of the slag cannot be fully utilized in principle and due to heat losses, since the blast furnace gas which absorbs heat in the example calculation is already at 170° C. on entering the heat exchanger and thus cannot cool the slag to ambient temperature. It is, however, readily conceivable to obtain the missing thermal output for heating the blast furnace gas to the desired turbine inlet temperature by combusting blast furnace gas. Approximately 1,300 Nm³/h of blast furnace gas would have to be combusted per MW of additional gross heat content which is required.

By way of comparison, expansion of the blast furnace gas at 45° C. from 2.2 bar(g) to 0.1 bar(g) (no pressure drop in heat exchangers) would result in a calculated power output at the shaft of 18.94 MW. The supplied 59.95 MW of heat are thus converted into mechanical energy at an efficiency of (34.28−18.94)/59.95=0.256 or just about 26%.

### BRIEF DESCRIPTION OF THE FIGURES

Further details and advantages of the invention may be inferred from the following detailed description of possible embodiments of the invention made with reference to the attached FIGURE, in which:

FIG. 1 is a diagram of the method and three alternative options for transferring heat from the hot slag to the blast furnace gas.

### DETAILED DESCRIPTION

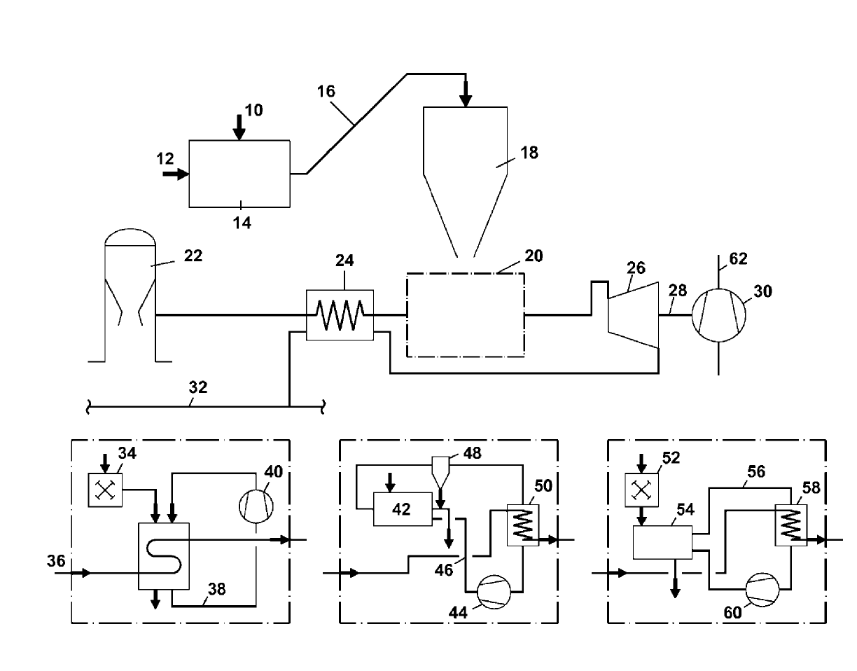

Various embodiments of this heat recovery and use for generating cold-air blast are explained below with reference to FIG. 1:

The liquid, hot slag 10 which is obtained periodically during each tapping operation is cooled by introduction of a cold solid 12 in a granulation installation 14 and solidifies, wherein the resultant hot solids mixture still has the highest possible temperature which is substantially limited by the subsequent processing of the mixture.

Cold, vitreously solidified blast furnace slag may, for example, be used as the cold solid. Using cold blast furnace slag has the advantage that, after the introduction thereof into the liquid slag, a homogeneous hot solids mixture is obtained.

Additionally or alternatively, however, spherical or similarly shaped metal bodies, preferably of iron or steel, may also be used as the cold solid. On introduction into the liquid slag, the metal bodies bring about more rapid solidification of the liquid slag and so increase the vitreous, i.e. non-crystalline, solidified fraction. This may be advantageous or necessary, depending on the further material use to which this slag is put.

The hot solids mixture which is obtained periodically during each tapping operation may be kept in intermediate storage in a buffer bunker or silo 18 and then continuously supplied as granulated slag to the apparatus 20 for heat recovery.

The hot solids mixture is then introduced into a heat-transfer apparatus 20. Three different variants of this heat-transfer apparatus 20 are shown in dot-dashed boxes A, B and C in FIG. 1.

The blast furnace gas from the blast furnace has solids removed from it in a wet cleaning apparatus 22, is enriched with steam and cooled to roughly 45° C. The wet, cold blast furnace gas is then heated in a preheater 24 to roughly 170° C. and then in a heat exchanger 20 to roughly 360° C. This hot blast furnace gas is fed into a blast furnace gas expansion turbine 26 and then used countercurrently as expanded, but still hot blast furnace gas in the preheater 24 in order to preheat the wet, cold blast furnace gas. The turbine 26 is driven by expansion of the blast furnace gas and the energy is transferred to a shaft 28 which drives the cold-air blast compressor 30. The compressed cold-air blast 62 is passed into the blast furnace. The expanded, cold blast furnace gas is finally fed into a clean gas system 32.

In a first variant of heat transfer from the slag to the blast furnace gas, as shown in dot-dashed box A of FIG. 1, the hot solids mixture is passed through a crusher 34, comminuted and transferred into a moving-bed cooler 36. In the moving-bed cooler 36, as for example described by the company Grenzebach, heat transfer proceeds from the solids mixture to the blast furnace gas passed through pipes on the cooler walls and/or in the bed.

Heat transfer may moreover be assisted and improved by an air circuit 38. The air enhances transfer of heat by convection between the solid and outer surfaces of the pipe. The air in the air circuit 36 is conveyed, for example, by a blower 40, upstream of which may be arranged a suitable solids separator, for example a cyclone.

In another embodiment of heat transfer from the slag to the blast furnace gas, as shown in dot-dashed box B of FIG. 1, the hot solids mixture is transferred into a ball mill or tube mill 42, where it is comminuted. The metal bodies used for cooling the liquid slag may optionally be used as grinding bodies or otherwise conventional grinding balls may be used. A blower 44 conveys air via an air circuit 46 into the mill 42. Said air heats up on the grinding bodies and on the millbase, is passed via a solids separator 48, for example a cyclone, and then releases heat to the blast furnace gas in a conventional heat exchanger 50.

In a further embodiment of heat transfer from the slag to the blast furnace gas, as shown in dot-dashed box C of FIG. 1, the hot solids mixture is passed through a crusher 52, comminuted and transferred into a rotating tubular cooler 54. In this rotating tubular cooler, as for example described by the company Grenzebach, heat transfer proceeds from the solids mixture by means of an air circuit 56. The air heats up on the tubes and then releases the heat to the blast furnace gas in a conventional heat exchanger 58. The air in the circuit is conveyed, for example, by a blower 60.

The blast furnace gas input into the above-stated method for heat recovery has an elevated temperature due to the first stage of preheating which has optionally already taken place in the heat exchanger between expanded blast furnace gas and blast furnace gas which is yet to be expanded. Cooling of the slag may therefore be limited and a second heat recovery stage may optionally be carried out subsequently.

1. A method for generating cold-air blast from slag heat, wherein the method comprises the following steps:
a. providing hot, granulated slag,
b. providing wet blast furnace gas,
c. preheating the wet blast furnace gas, whereby preheated blast furnace gas is obtained,
d. transferring heat from the hot, granulated slag to the preheated blast furnace gas, wherein hot blast furnace gas is obtained,
e. expanding the hot blast furnace gas in a turbine, wherein energy is released and expanded blast furnace gas is obtained,
f. using the released energy to drive a cold-air blast compressor for compressing the cold-air blast wherein the compressed cold-air blast is passed into the blast furnace,
wherein a shaft is driven by expansion of the hot blast furnace gas in a turbine, wherein said shaft drives the cold-air blast compressor and wherein the expanded blast furnace gas is used for preheating the wet blast furnace gas, whereby cold, expanded blast furnace gas is obtained.

2. The method according to claim 1, wherein the wet blast furnace gas has a pressure of 2 to 4 bar(g) and a temperature of 30 to 60° C.

3. The method according to claim 1, wherein the preheated blast furnace gas has a pressure of 2 to 4 bar(g) and a temperature of 140 to 200° C.

4. The method according to claim 1, wherein the hot blast furnace gas has a pressure of 2 to 4 bar(g) and a temperature of 300 to 420° C.

5. The method according to claim 1, wherein the expanded blast furnace gas has a pressure of 0.05 to 0.4 bar(g).

6. The method according to claim 1, wherein the hot, expanded blast furnace gas has a temperature of 400 to 290° C.

7. The method according to claim 1, wherein the cold expanded blast furnace gas has a temperature of 30 to 80° C.

8. The method according to claim 1, wherein the hot, granulated slag is provided in that hot liquid slag is cooled by introduction of a cold solid and solidifies.

9. The method according to claim 8, wherein cooled, vitreously solidified slag and/or metal bodies are used as the cold solid.

10. A method according to claim 1, wherein heat transfer from the hot, granulated slag to the wet blast furnace gas proceeds in a moving-bed cooler, in a tubular cooler and/or in a ball mill or tube mill.
